(19) United States
(12) Patent Application Publication
(10) Pub. No.: US 2007/0184205 A1
(43) Pub. Date: Aug. 9, 2007

(54) PAPERBOARD FOR USE IN WATER RESISTANT PACKAGING

(76) Inventors: Randall E Bailey, Cumming, GA (US); William G. Lanier, Marietta, GA (US)

Correspondence Address: MEADWESTVACO CORPORATION, 1021 MAIN CAMPUS DRIVE, 3RD FLOOR, CENTENNIAL CAMPUS, RALEIGH, NC, 27606, US

(21) Appl. No.: 11/560,240

(22) Filed: Nov. 15, 2006

Related U.S. Application Data
(60) Provisional application No. 60/737,210, filed on Nov. 16, 2005.

(51) Int. Cl. B05D 1/28

(52) U.S. Cl. 427/428.01

(57) ABSTRACT

A method of producing paperboard and cartons made therefrom is described incorporating a waterproof or water resistant coating applied to the interior of the carton except for areas intended for gluing. A coating material is applied to the surface of an applicator roll, and a portion of the coating material is then removed from the roll. Contact between a paperboard web and the roll transfers coating material to the web, creating a coated surface except for an uncoated stripe. A carton may be formed from the coated web with the uncoated portion of the carton cut from the uncoated strip.

### CROSS REFERENCE TO RELATED APPLICATION

This application claims the benefit of priority under 35 U.S.C. §119(e) of provisional application Ser. No. 60/737,210, filed Nov. 16, 2005.

### BACKGROUND

Paperboard cartons are often used for packaging beverage containers cans and bottles. During packaging, cold or chilled beverage containers may be placed into the cartons and condensation from the air may form on the containers and drip onto the inside surfaces of the paperboard carton. This may weaken the carton, or cause reduced adhesion of external coatings resulting in deterioration or rub-off of graphics printed on the external coatings.

To protect against moisture absorption, the inside of the paperboard carton may be coated with a waterproofing or water resisting material. However, such materials reduce the adhesion of sealants used upon the flaps of the paperboard carton, so that the integrity of the carton may be compromised. To retain sealant adhesion, it is desirable that the waterproofing material be selectively applied to the interior surface of the paperboard, with the material not applied to areas intended for gluing. For other purposes, selective application may typically be done by a printing method, such as flexographic, rotogravure, or offset printing, but such methods typically cannot apply sufficient coat weights of the waterproofing material. Coat weights in range of 2.5 lb/1000 ft² are required, which can be applied by technologies such as rod coating used in papermaking, but these typically coat the entire surface. A method is desired that will allow the waterproofing material to be selectively applied at the higher coat weights that are typically achieved by paper machine coaters.

### SUMMARY

The present invention provides a method whereby sufficiently high coat weights of waterproofing materials are applied to the “inside ” surface of a paperboard intended for use as a packaging material. Selected areas of the inside surface, preferably those areas to be glued, are left without the waterproofing material, in order to provide superior glue adhesion.

A method for producing a paperboard product having separate coated and uncoated areas is provided, in which a substrate web is moved over a rotating applicator roll so as to define a region of contact between the web and the roll. A coating material is applied to the surface of the applicator roll at an application location remote from the region of contact. A coating removal device is positioned adjacent the roll between the application location and the region of contact to remove a portion of the coating material from at least one area on the roll. Contact between the web and the roll transfers the coating material to the web, creating a coated surface except for a stripe corresponding to the portion of the coating material removed the said roll.

The method may include removing the coating material by a wiping action. The coating removal device may include a doctor blade disposed in contact with the surface of the roll.

The coating material may be applied to the roll by positioning a coating reservoir containing the coating material adjacent to the roll at the application location so that the surface of the roll contacts the coating material.

The applicator roll may also include at least one recessed area defined in the surface of the roll, whereby no contact is made between the roll and the web along said recessed area, thereby defining an uncoated area on the web corresponding to the recessed area.

In accordance with another embodiment of the invention, a method for producing a paperboard product having separate coated and uncoated areas includes the steps of extruding a coating material from an extruder having an elongated slot for the coating material to create a film of coating material. A portion of the slot is blocked to create a gap in the film of coating material. The film of coating material is then applied to a substrate web to produce a coated substrate web with at least one uncoated area thereon.

In accordance with still another embodiment of the invention, a method for producing a paperboard carton blank includes moving a substrate web over a rotating applicator roll so as to define a region of contact between the web and the roll. A coating material is applied to the surface of the applicator roll at an application location remote from the region of contact. A coating removal device is positioned adjacent the roll between the application location and the region of contact to remove a portion of the coating material from at least one area on the roll. Contact between the web and the roll transfers the coating material to the web, creating a coated surface except for a stripe corresponding to the portion of the coating material removed from the roll. A carton blank is then cut from the web so that an uncoated area of the blank is formed from substrate located along the stripe.

The uncoated area of the blank may be used to form the flaps of the carton.

### BRIEF DESCRIPTION OF THE DRAWINGS

FIG. 1 illustrates a typical prior art coating process;

FIG. 2 illustrates an embodiment of the invention directed to providing uncoated stripes on a paperboard product;

FIG. 3 illustrates a paperboard carton blank with uncoated areas intended for gluing;

FIG. 4 illustrates an alternative embodiment of the invention directed to providing patterned uncoated areas on a paperboard product.

### DETAILED DESCRIPTION

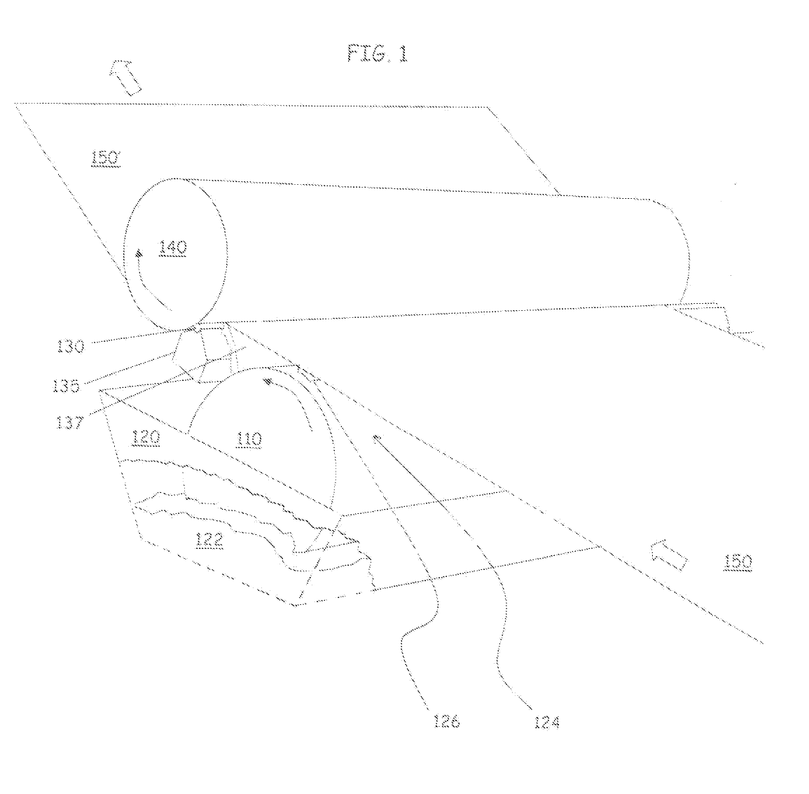

FIG. 1 illustrates a typical coating process. An applicator roll 110 rotates in a pan 120 containing a coating material 122. The rotation of the applicator roll 110 through the coating material 122 results in a film of coating material upon the surface of the applicator roll 110 in the region indicated at 124. A web 150, for example of paper or paperboard, moves in contact with applicator roll 110, causing part of the coating film to be transferred onto the web 150, for example in a contact area or meniscus 126.

Typically there may be an excess of coating deposited onto the web. To remove excess coating, a device such as rod 130 may be placed in contact with web 150. The rod 130 may be supported by rod bed 135. A backing roll 140 may be provided to form a nip between the backing roll 140 and the rod 130, through which the web 150 passes, thus removing excess coating from the web, as shown by excess coating 137 draining away from the rod 130, and back into pan 120. Finally, the coated web 150′ continues on, for example to a drying process.

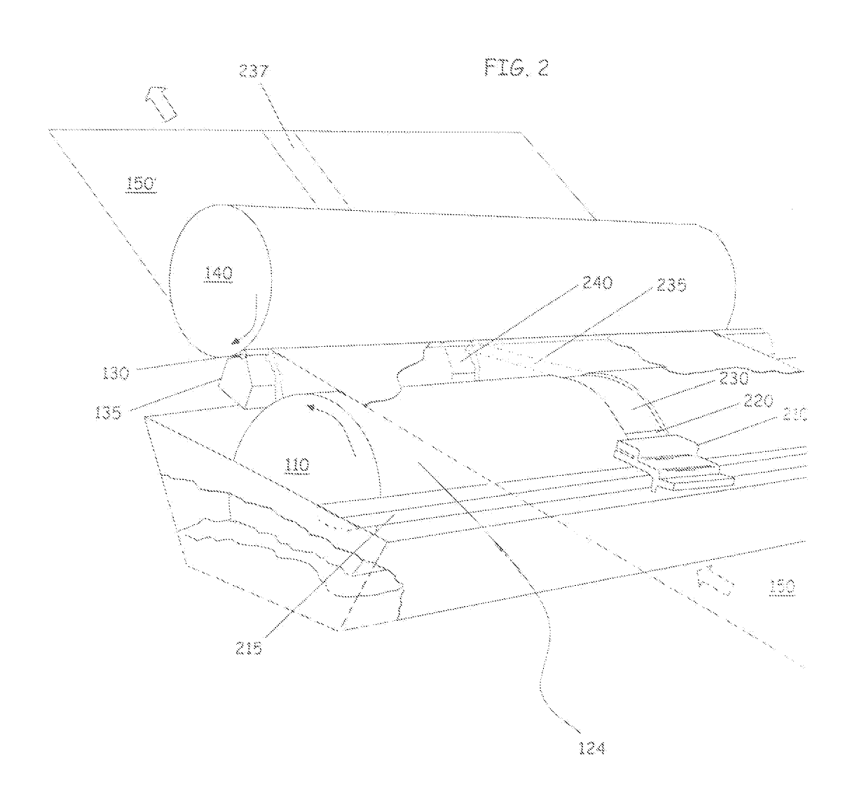

In accordance with a preferred embodiment of the invention, FIG. 2 illustrates a method for providing an uncoated stripe on a web. To accomplish this, a holder 210 holds a wiper 220 against the applicator roll 110, so that the coating material film 124 may be wiped clean from the applicator roll as shown by area 230. The wiper 220 may be a rigid, semi-rigid, or flexible device, for example a doctor blade, squeegee, wiper, roller, air blast, etc. When the web 150 contacts the applicator roll 110, the web is left with a dry stripe 235. Upon contact with the rod 130, there may be some spreading of the coating upon the web, but typically there will still remain a dry stripe on the web in the machine direction, as evidenced by an area 240 of no excess wipe-off by the rod 130. It may be necessary to use a short series of trials to determine the best placement and width of wiper 220 in order to provide the correct width of the final dry stripe 237 upon web 150. The wiper 220 may be supported upon a support beam 215, from whence its position may be adjusted. More than one wiper may be used to give multiple dry stripes.

The coated web may be used in the manufacture of paperboard articles such as cartons. The web 150′, after leaving the coating apparatus may be wound into a roll and transported to separate equipment for carton manufacture. Alternatively, the coating apparatus may be incorporated into the carton manufacturing equipment. In such case, the web 150′ may be fed into one or more printing stations where the web is printed using flexographic, gravure, or other printing methods on the side opposite the applied coating 124. The printed web is then directed into cutting equipment that cuts printed carton blanks from the moving web.

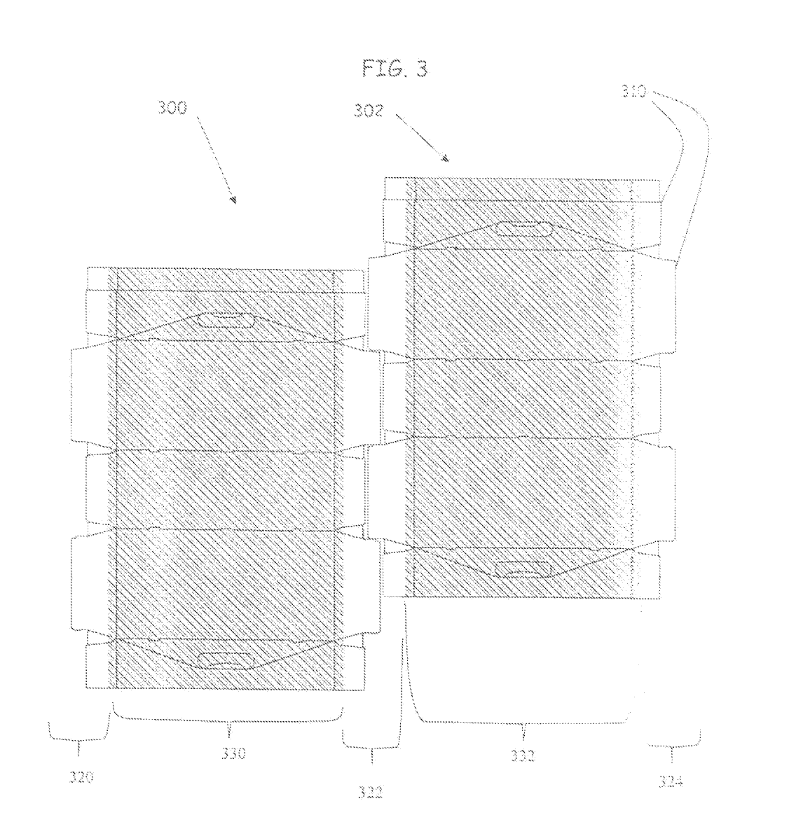

FIG. 3 illustrates the formation of two paperboard carton blanks 300, 302 from the coated web. Although only two are shown for illustration purposes, typically several blanks would be fitted in the cross direction of a paperboard web, and hundreds or thousands would fit in the machine (long) direction of a paperboard web. The blanks may be offset slightly in the long direction (as shown) in order to minimize waste of the paperboard material. The carton blanks have flaps 310 that are typically folded and glued during assembly. These flaps 310 fit in areas 320, 322, 324 that are not coated. The non-flap portions of the carton blanks fit in areas 330, 332 that are coated, for example with a waterproofing material. The coating may preferably extend partway onto the flaps 310 provided uncoated area sufficient for gluing is left uncoated on the tabs. However, depending on the carton design, the coating areas 330, etc. may be narrower or wider than shown.

In addition to imparting water resistance or water proofing, the coating may impart additional strength to the carton blank, and allow the use of lighter weight or lower caliper paperboard. The coating may itself provide strength, or may prevent loss of strength that may occur if the paperboard were to become wetted.

Carton blanks with portions coated to provide desirable properties (such as water resistance or water proofing) and other portions not coated to provide other desirable properties (such as superior gluability) may also be produced by methods such as extrusion coating. For example, to create uncoated stripes using an extrusion coater, portions of the extruder die slot may be closed, for example with blocks, to prevent flow from those areas of the slot. An extrusion coating upon exit from a die may exhibit “die swell” and upon travel from the die to the substrate may exhibit “neck-down”, either of which may cause the width of the uncoated stripe to differ from the width of a block in the die opening. Simple experimentation will suffice to determine the appropriate block width to achieve the desired uncoated stripe width.

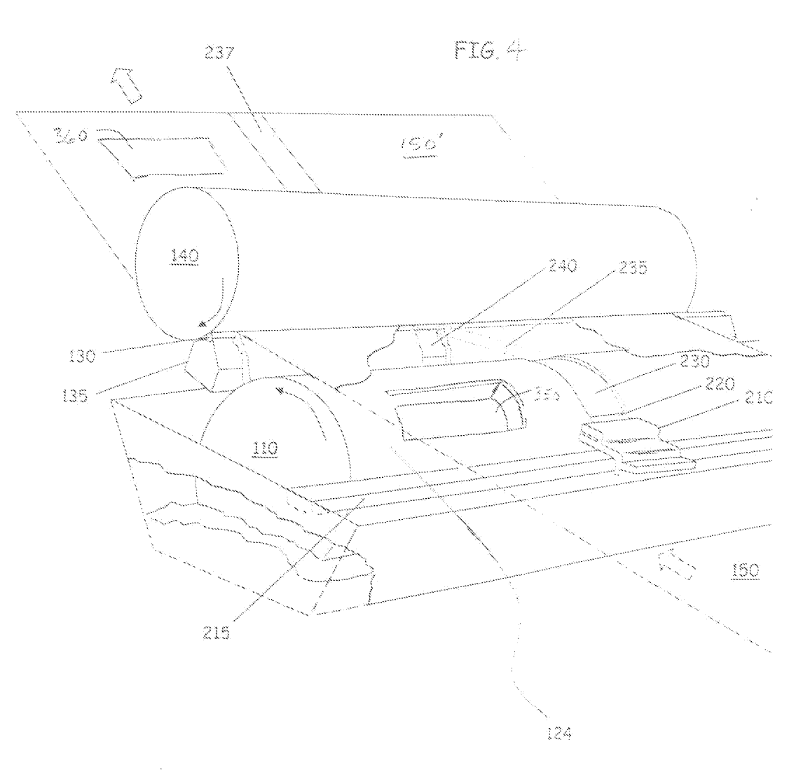

FIG. 4 illustrates an alternate embodiment for the present invention in which further areas of the web may be left uncoated. This can be particularly useful, e.g., if a transverse region of a carton blank is to be used for gluing. The apparatus is the same as that shown in FIG. 2, except that a recess 350 is formed into the surface of applicator roll 110 to correspond to the desired uncoated area. As roll is rotated through the coating material 122, either no coating material will adhere to the roll on the recess 350, or if it does, it will be carried at the bottom of recess 350. In either case, no coating will be transferred to web 150 in this area, with the result that an uncoated area 360 will be formed repeatedly in a corresponding pattern on web 150′. By properly selecting and positioning one or more recesses 350 on roll 110, the desired uncoated pattern may be produced.

Suitable coating materials are known to those skilled in the art. Such materials may be selected based upon the desired properties to be achieved by coating. For example, such coatings may be used to provide enhanced water resistance, grease or oil resistance, or improved tearing strength.

Methods of making and using the paperboard and the paperboard carton in accordance with the invention should be readily apparent from the mere description as provided herein. No further discussion or illustration of such products or methods, therefore, is deemed necessary.

While preferred embodiments of the invention have been described and illustrated, it should be apparent that many modifications to the embodiments and implementations of the invention can be made without departing from the spirit or scope of the invention. Although the preferred embodiments illustrated herein have been described in connection with a paperboard structure with a waterproofing material applied in a pattern through a particular coating process, these embodiments may easily be implemented in accordance with the invention in other structures or to by other application methods.

It is to be understood therefore that the invention is not limited to the particular embodiments disclosed (or apparent from the disclosure) herein, but only limited by the claims appended hereto.

What is claimed:

1. A method for producing a paperboard product having separate coated and uncoated areas, comprising the steps of:
moving a substrate web over a rotating applicator roll so as to define a region of contact between said web and said roll;
applying a coating material to the surface of said applicator roll at an application location remote from said region of contact;
positioning a coating removal device adjacent said roll between said application location and said region of contact to remove a portion of said coating material from at least one area on said roll;
whereby contact between said web and said roll transfers said coating material to said web, creating a coated surface except for a strip corresponding to the portion of said coating material removed from said roll.

2. The method of claim 1, wherein the removing of said coating material by said coating removal device is performed by a wiping action.

3. The method of claim 2, wherein said coating removal device includes a doctor blade disposed in contact with the surface of said roll.

4. The method of claim 1, wherein said coating material is applied to said roll by positioning a coating reservoir containing said coating material adjacent to said roll at said application location so that the surface of said roll contacts said coating material.

5. The method of claim 1, wherein said applicator roll includes at least one recessed area defined in the surface of said roll, whereby no contact is made between said roll and said web along said recessed area, thereby defining an uncoated area on said web corresponding to said recessed area.

6. A method for producing a paperboard product having separate coated and uncoated areas, comprising the steps of:
extruding a coating material from an extruder having an elongated slot for said coating material to create a film of said coating material;
blocking a portion of said slot to create a gap in said film of coating material; and
applying said film of coating material to a substrate web to produce a coated substrate web with at least one uncoated area thereon.

7. A method for producing a paperboard carton blank, comprising the steps of:
moving a substrate web over a rotating applicator roll so as to define a region of contact between said web and said roll;
applying a coating material to the surface of said applicator roll at an application location remote from said region of contact;
positioning a coating removal device adjacent said roll between said application location and said region of contact to remove a portion of said coating material from at least one area on said roll;
whereby contact between said web and said roll transfers said coating material to said web, creating a coated surface except for a stripe corresponding to the portion of said coating material removed from said roll;
cutting a carton blank from said web so that an uncoated area of said blank if formed from substrate located along said stripe.

8. The method of claim 7, wherein said uncoated area of said blank forms the flaps of the carton.
